(19) United States
(12) Patent Application Publication
(10) Pub. No.: US 2011/0288891 A1
(43) Pub. Date: Nov. 24, 2011

(54) ON-DEMAND THIRD PARTY ASSET RENTAL PLATFORM

(75) Inventors: Sam Zaid, Ottawa (CA); Elliot Kroo, San Francisco, CA (US); Charles Du, Sunnyvale, CA (US); Jessica Scorpio, San Francisco, CA (US)

(73) Assignee: GETTAROUND, INC., San Francisco, CA (US)

(21) Appl. No.: 13/099,279

(22) Filed: May 2, 2011

Related U.S. Application Data
(60) Provisional application No. 61/330,823, filed on May 3, 2010.

(51) Int. Cl. G06Q 30/00; G06Q 50/00

(52) U.S. Cl. 705/4; 705/26.4

(57) ABSTRACT

An on-demand third party asset rental platform is provided. In some embodiments, on-demand third party asset rental platform includes a self-service platform that enables a third-party renter to electronically submit a conditional rental offer (CRO) for an asset to a plurality of third-party owners of that asset. In some embodiments, on-demand third party asset rental platform includes receiving a request for an asset (e.g., a vehicle or another type of asset) rental; and in response to the request for an asset rental, communicating a plurality of conditional rental offers to a plurality of asset owners, wherein each of the asset owners specifies the asset owner's rental terms. In some embodiments, an asynchronous protocol for CRO distribution is provided.

### CROSS-REFERENCE TO RELATED APPLICATIONS

This application claims priority to U.S. Provisional Patent Application No. 61/330,823 (Attorney Docket No. GETTP002+), entitled ON-DEMAND THIRD PARTY ASSET RENTAL PLATFORM filed May 3, 2010, which is incorporated herein by reference for all purposes.

### BACKGROUND OF THE INVENTION

Online rental platforms exist. For example, commercial car rental companies typically provide a web site that allows customers to reserve a car for rental for a specified date and time.

Online reverse auction based market place web sites also exist. For example, some companies provide web sites that offer discounts on products or services by allowing customers to specify their price terms and allowing sellers of products or services to compete on price and to respond to such price terms in a form of a reverse auction (e.g., Priceline's “Name Your Own Price” is typically used to book hotels and flights using a conditional purchasing system).

### BRIEF DESCRIPTION OF THE DRAWINGS

Various embodiments of the invention are disclosed in the following detailed description and the accompanying drawings.

FIG. 1 is a functional diagram of an on-demand third party asset rental platform in accordance with some embodiments.

FIG. 2 is a functional diagram of a controller of the on-demand third party asset rental platform in accordance with some embodiments.

FIG. 3 is a flow diagram of an owner asset listing process using an owner interface in accordance with some embodiments.

FIG. 4 is a flow diagram of a Conditional Rental Offer (CRO) process using a renter interface in accordance with some embodiments.

FIG. 5 is a flow diagram of a Conditional Rental Offer (CRO) distribution using a notification engine in accordance with some embodiments.

FIG. 6 is a flow diagram of a Conditional Rental Offer (CRO) acceptance in accordance with some embodiments.

FIG. 7 is a messaging sequence diagram for an asynchronous CRO distribution protocol for an on-demand third party asset rental platform in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

### Overview of Terminology

Car is used synonymously with vehicle. Car is understood to include cars, buses, RVs, bikes, scooters, and any other form of vehicular transportation. Car is used as an example asset for the purposes of this description but is only one of a plurality of applications of the platform. In some embodiments, assets can also include cars, homes, sports equipment, home supplies, and a plurality of other rentable assets owned by third party individuals.

Online peer-to-peer marketplace refers to an electronic marketplace that connects third party buyers with third party sellers to list and exchange both goods and services in a self-service manner. Sellers list their products for sale in auction or fixed price format via the marketplace. Buyers bid on the product or purchase the product outright directly from the seller. The online marketplace acts only to coordinate the transaction but does not perform any logistics or supply chain services. This creates a highly efficient marketplace where buyers can buy goods and services directly from sellers.

Conditional purchasing system refers to an online system that allows a buyer to specify a desired price, which forms a conditional purchase offer that the system automatically delivers to one or more sellers. Priceline's “Name Your Own Price” is an example of such a system and is typically used to book hotels and flights.

Automatic vehicle location (AVL) refers to a mechanism and/or techniques for automatically determining the geographic location of a vehicle and transmitting the information to a requester. Geographic positioning is most commonly determined using satellite positioning (e.g., GPS) or wireless locating systems (e.g., RTLS). After position capture, data transmission occurs over satellite, terrestrial, or cellular communications networks. Most commonly used are cellular networks that transmit data over SMS, GPRS, or EDGE.

AVL hardware refers to an-vehicle hardware is required to support AVL systems. For example, hardware components commonly installed in a vehicle can include the following devices and/or other devices as would be apparent to one of ordinary skill in the art. AVL hardware can include a GPS unit for accurate and real-time geo-location capture. AVL hardware can include a telemetry device for transmitting captured position data over the desired medium (e.g., satellite, terrestrial radio, cellular). A common implementation choice is a GSM modem transmitting data over either SMS or GPRS/EDGE. A hardware interface to the vehicle control bus and primary ECU for capturing vehicle sensor readings (e.g., RPMs, engine status) and trigger vehicle actuators (e.g., Door locks). This typically leverages SAE standards such as CAN-bus and/or LIN-bus. An MPU (microprocessor unit) or MCU (microcontroller unit) to handle computer communications, store data, and coordinate the activities of the full AVL system. A backup battery that powers the AVL hardware components when the car is turned off in order to avoid draining the main car battery.

Smartphone push refers to a mobile phone offering the advanced capabilities of a personal computer such as email, high-speed Internet access, audio and video capabilities, a rich visual interface, advanced interaction techniques (e.g., multi-touch), and GPS functionality. In particular, smartphone push technology generally includes push capability to send notifications directly to the mobile device as or near in time to when they occur.

Short Message Service (SMS) refers to a communication service standardized in the GSM mobile communication system, using standardized communications protocols allowing the interchange of short text messages between mobile telephone devices. SMS text messaging is currently a very widely used data application, with 2.4 billion active users, or 74% of all mobile phone subscribers sending and receiving text messages on their phones.

Multimedia Message Service (MMS) refers to a similar standard (e.g., similar to SMS) that supports the addition of audio, images, and video to messages.

Web application refers to an application, typically browser-based, that is accessed over a network such as the Internet or an intranet.

Mobile app or mobile application refers to an application developed for handheld devices such as personal digital assistants, enterprise digital assistants, or mobile phones. These applications are either pre-installed on phones during manufacture, or downloaded by customers from app stores and other mobile software distribution platforms.

### Overview of Embodiments

Online rental platforms exist. For example, commercial car rental companies typically each provide a web site that allows their respective customers to reserve a car for rental for a specified date and time.

However, existing online vehicle rental approaches assume that the vehicles are available to rent at all times, except if the particular vehicle is currently rented and/or reserved for a rental. In particular, such existing online vehicle rental approaches assume that the vehicles are all owned or leased by the vehicle rental company and that when the vehicle is not currently rented and not reserved for rental, then the vehicle is generally available for rental by a vehicle rental customer. Also, while owners may advertise/post/publish approximate availability of their vehicles for rental, the actual availability of their vehicle for rental is not precisely known for any given future time period prior to a rental request acceptance.

Existing reverse auction based market place web sites may offer discounts on products or services by allowing customers to specify their price terms and allowing sellers of products or services to compete on price and to respond to such price terms in a form of a reverse auction (e.g., Priceline's “Name Your Own Price” is typically used to book hotels and flights using a conditional purchasing system). However, this approach for reverse auction based market place web sites does not solve the problem that arises when handling a delayed feedback from an owner as to whether or not the vehicle is available to rent in response to a vehicle rental request in which whether or not a desired asset, such as a vehicle, is available or not during a specified time interval is not known in advance of communicating the vehicle rental offer and receiving a confirmation response (e.g., acceptance to the vehicle rental offer).

What is needed is an on-demand third party asset rental platform. In some embodiments, an on-demand third party asset rental platform is provided. In some embodiments, the on-demand third party asset rental platform is a flexible asset rental platform that facilitates ad hoc availability of asset (e.g., vehicle or other asset) availability for rental, such as when the asset is not currently rented and not reserved for rental but is still otherwise unavailable for rental (e.g., a car owner who participates in a car sharing service may not be using the car on a particular weekend but also may not want to allow their car to be rented that weekend). In some embodiments, an on-demand third party asset rental platform also includes generating and communicating conditional rental offers (CROs). In some embodiments, an on-demand third party asset rental platform includes distributing conditional rental offers (CROs) using an asynchronous communication protocol. For example, an on-demand third party asset rental platform can provide a flexible vehicle rental platform for a vehicle-sharing network, such as a social vehicle sharing service or peer-to-peer vehicle sharing service, such as that provided by Gettaround, Inc.

Vehicle (e.g., automobile or car) owners generally invest significant amounts of time and money into an asset that they did not use all of the time. For example, automobiles are generally driven less than about 10% of the time, which means that these assets are generally underutilized assets. A social car sharing service or peer-to-peer car sharing service can allow for a more effective utilization of cars. As an example, a car sharing service can enable car owners to safely rent out their underutilized cars to a community of trusted drivers (e.g., allowing for car rentals by the hour and/or day using an on-demand third party car rental platform, as described herein with respect to various embodiments). This approach allows drivers to have access to a vehicle on demand, when needed, while requiring fewer cars by improving car utilization. Moreover, this approach empowers people to travel more efficiently and shifts transportation from a personal transport to a shared transport paradigm.

In some embodiments, an on-demand third party asset rental platform includes a processor of a system configured to receive a request for a vehicle rental from a renter (e.g., a digitally signed conditional rental request); and in response to the request for a vehicle rental, communicate a conditional rental offer (CRO) as a plurality of rental offers distributed to a plurality of owners, wherein each of the owners specifies an owner's prices; and a memory coupled to the processor and configured to provide the processor with instructions. For example, an on-demand third party asset rental platform can facilitate renting a vehicle from someone nearby using a convenient hourly rental protocol for quick and convenient vehicle rentals. As another example, CROs can be generated and communicated for requesting multiple vehicles potentially in parallel (e.g., at the same time or during an overlapping time interval) in response to a vehicle rental request in which the first owner to accept is allocated the rental transaction).

In some embodiments, one or more of the owners' prices includes a plurality of parameters in addition to the price. In some embodiments, a plurality of vehicles are corporate fleet vehicles associated with a corporate entity, and fees associated with rentals of the corporate fleet vehicles by authorized corporate fleet vehicle users are charged back to the corporate entity. In some embodiments, a plurality of vehicles include both corporate fleet vehicles associated with a corporate entity and personal vehicles, and fees associated with rentals of the corporate fleet vehicles by authorized corporate fleet vehicle users are charged back to the corporate entity. In some embodiments, the conditional rental offers include one or more preferences related to the vehicle rental. In some embodiments, the conditional rental offers include one or more required preferences and/or one or more required preferences related to the vehicle rental. In some embodiments, the owner pays rental insurance cost for an approved vehicle rental. In some embodiments, the owner pays rental insurance cost for an approved vehicle rental, and the vehicle rental price includes a calculated cost of the rental insurance cost for the approved vehicle rental. In some embodiments, the owner can include a “donate to my cause” charitable donation whereby an asset is associated with a chosen charity causing a component (e.g. a percentage) of the rental transaction to be donated to the associated charity.

In some embodiments, an on-demand third party asset rental platform further includes storing response information for a plurality of owners, wherein the response information includes an average response time and/or average response rate. In some embodiments, an on-demand third party asset rental platform further includes storing a list of favorite vehicles associated with the renter. In some embodiments, an on-demand third party asset rental platform further includes storing a list of preferred renters for a first owner, wherein one or more of the preferred renters are preauthorized for renting the first owner's vehicle.

In some embodiments, an on-demand third party asset rental platform further includes communicating the plurality of conditional rental offers to the plurality of owners asynchronously to distribute the conditional rental offers to provide one or more selected of the plurality of owners advanced opportunities to respond to the conditional rental offers. In some embodiments, an asynchronous protocol for CRO distribution over a communication network is provided. For example, the asynchronous protocol for CRO distribution can implement an asynchronous algorithm for CRO distribution that varies the CRO distribution based on time, parameters related to the asset rental request, and/or other factors. Various embodiments for an asynchronous protocol for CRO distribution are described herein.

In some embodiments, an on-demand third party asset rental platform further includes communicating updated conditional rental offers. In some embodiments, an on-demand third party asset rental platform further includes the ability for an owner to explicitly set times in which the asset is available to be rented. In some embodiments, this availability preference is used to automatically reject CROs that do not fall within the availability window. In some embodiments, this availability preference can be specified uniquely for each renter or class of renter. In some embodiments, an on-demand third party asset rental platform further includes automatically approving the conditional rental offer for a first owner based on one or more parameters (e.g., based on a class of the renter such as the renter being included in the owner's favorite renters class, date/time for the rental, renter feedback rating, availability preferences, and/or other parameters). In some embodiments, an on-demand third party asset rental platform further includes automatically approving the conditional rental offer for a first owner based on one or more parameters; and communicating the approved response from the first owner.

In some embodiments, an on-demand third party asset rental platform further includes communicating an acceptance of the conditional rental offer for a first owner; and communicating a digital access key that facilitates keyless entry into the first owner's vehicle, wherein the digital access key is a digital access token to a computerized entry system installed in the first owner's vehicle.

In some embodiments, an on-demand third party asset rental platform further includes communicating a plurality of messages between the renter and a first owner (e.g., prior to completing a vehicle rental transaction and/or after the completed rental transaction). In some embodiments, messaging between the renter and owner can continue after completing a vehicle rental transaction.

In some embodiments, an on-demand third party asset rental platform further includes automatically generating the conditional rental offer based on a plurality of rental parameters input by the renter.

In some embodiments, an on-demand third party asset rental platform further includes calculating differentiating pricing for the renter for a one or more of the owners. In some embodiments, an on-demand third party asset rental platform further includes calculating differentiating pricing for the renter for one or more of the owners based on a preference setting configured by the owner for one or more of the renters.

In some embodiments, an on-demand third party asset rental platform further includes generating a rent it now offer for a first owner, wherein rent it now offer includes a plurality of required parameters including a time interval and a rental price.

In some embodiments, an on-demand third party asset rental platform further includes verifying the renter based on vehicle rental information. In some embodiments, an on-demand third party asset rental platform further includes verifying the renter based on driving record information. For example, a driver check can be performed based on a driver's license number (e.g., executed on demand, either synchronously, in real-time when the request is initiated or received, or asynchronously, executing, for example, a multi-jurisdictional Driver Motor Vehicles (DMV) search, which can take about 30 seconds to several minutes to complete). In some embodiments, an on-demand third party asset rental platform further includes verifying the renter based on vehicle rental payment information. For example, a credit card check can be performed based on the requesting renter's provided credit card number. In some embodiments, an on-demand third party asset rental platform further includes verifying the renter based on social graph information.

In some embodiments, an on-demand third party asset rental platform further includes determining a relationship between the renter and a first owner based on a social graph. For example, some or all of the social graph information can be imported from an existing social network (e.g., using a seed social graph data from a third party social graph source, in which the social graph includes relationships between renters and owners, and possibly between renters and other renters, and/or owners and other owners), such as Facebook®, MySpace®, and/or LinkedIn®. In some embodiments, an on-demand third party asset rental platform further includes generating a social graph, wherein the social graph includes relationships between the renter and the plurality of owners.

In some embodiments, an on-demand third party asset rental platform includes a method for receiving a request for a vehicle rental from a renter; and in response to the request for a vehicle rental, communicating a conditional rental offer as a plurality of conditional rental offers distributed to a plurality of owners, wherein each of the owners specifies an owner's prices.

In some embodiments, an on-demand third party asset rental platform further includes a computer program product, the computer program product being embodied in a computer readable storage medium and including computer instructions for receiving a request for a vehicle rental from a renter; and in response to the request for a vehicle rental, communicating a conditional rental offer as a plurality of conditional rental offers distributed to a plurality of owners, wherein each of the owners specifies an owner's prices.

In some embodiments, an on-demand third party asset rental platform is provided that includes a self-service platform that enables a third-party renter to electronically submit a conditional rental offer (CRO) for an asset to a plurality of third-party owners of that asset. In some embodiments, third party assets include vehicles (e.g., automobiles, motorcycles, and/or other types of vehicles). In some embodiments, third party assets include various other types of third party assets that can be rented, such as home, boat, plane, jet, and/or sports or other transportation equipment (e.g., bicycles, skis, and/or other sports or transportation equipment).

Unlike a traditional rental system, an on-demand third party asset rental platform cannot guarantee the availability of the third party asset. The exact location and usage patterns are only known to each owner of a particular third party asset, and the system is not fully aware of its scheduled availability.

In some embodiments, conditional rental techniques that address this availability challenge are provided as described herein. Unlike a conditional offer system, the primary motivation of the approach is not the optimization of price for the renter. The renter does not submit an offer price in the conditional rental and monetary exchange is not always required. Additionally unlike a conditional offer system, the platform cannot guarantee a response from an owner as they are typically third party individuals renting their asset on an ad-hoc basis.

Rather, an on-demand third party asset rental platform is optimized to deliver a rapid response by distributing conditional rental offers to a multiple asset owners and, in some cases, to also accommodate a renter's asset preferences in accordance with some embodiments. For example, as individually owned assets can vary significantly in characteristics (e.g., age, location, style, size, and/or other characteristics), the renter can formulate a conditional rental offer (CRO) by selecting one or more assets with an indication of desirability for each (e.g., in some cases, all desired assets can have the same desirability). As another example, a renter can specify a different date and time for each different asset in a CRO instead of simply specifying a single date and time for all of the different assets in the CRO.

In some embodiments, an on-demand third party asset rental platform is provided to bind the conditional rental offer to the most desired asset within a minimum amount of time, in an environment with asset availability uncertainty and a large number of distributed third-party asset owners.

In some embodiments, the on-demand third party asset (e.g., vehicle) rental platform includes a web or mobile interface for an owner to list their vehicle with an associated rental price. In some embodiments, the on-demand third party asset rental platform includes a web or mobile interface for a renter to input a conditional rental request includes a rental period and either the type of vehicle desired or optionally a list of one or more vehicles selected by the renter, and a payment identifier (e.g., credit card or PayPal®). In some embodiments, the payment identifier can correspond to “credits” that have been pre-paid or earned prior to the creation of the CRO. In some embodiments, the on-demand third party asset rental platform includes a controller and push notification system capable of delivering conditional rental requests in an optimal way from a renter to a plurality of owners associated to the vehicles selected by the renter, with an option to accept or decline the request. In some embodiments, these requests are delivered in “near real-time”, in which near real-time is used herein to refer to an amount of time that accounts for delays introduced by artifacts, such as automated data processing, software systems, and network transmission. In some embodiments, the on-demand third party asset rental platform includes a web or mobile interface for an owner to input an acceptance in response to a conditional rental request. In some embodiments, the on-demand third party asset rental platform includes a payment engine for collecting payment from the renter and later disbursing payment to the owner using the payment identifier.

In some embodiments, an on-demand third party asset rental platform provides an on-demand vehicle rental method between a renter and owner including inputting a conditional rental request that includes a rental period, the type of vehicle desired or optionally a list of one or more vehicles selected by the renter, and a payment identifier into a computer or phone (e.g., tablet or smartphone or another computing/phone device). In some embodiments, the on-demand third party asset rental platform includes electronically sending the conditional rental request in an optimal manner to the plurality of owners of the vehicles selected by the renter with an option to accept or decline the request (e.g., using a distributed communication of CROs using an asynchronous protocol as described herein with respect to various embodiments). In some embodiments, the on-demand third party asset rental platform includes inputting an acceptance to a conditional rental request by an owner into a computer or phone (e.g., tablet or smartphone or another computing/phone device). In some embodiments, the on-demand third party asset rental platform includes providing a payment to the owner using the payment identifier.

In some embodiments, the on-demand third party asset rental platform includes the extension of the various techniques described above, including combinations thereof, to any type of third-party asset including, for example, vehicles, homes, sports equipment, tools, home supplies, bikes, and other assets.

Traditional car rental systems require purchasing, storing, and maintaining a dedicated fleet of vehicles. By allowing any owner to supply their vehicle, the various techniques for an on-demand third party asset rental platform described herein in accordance with some embodiments circumvents the costs and limitations in the traditional rental model.

For example, an on-demand rental confirmation system that rapidly notifies the car owner of a rental request circumvents the need for an owner to specify in advance when their car is available and/or unavailable to rent. This allows a car owner to use their car in a standard manner with minimal schedule constraints.

As another example, broadcasting the rental request to multiple owners simultaneously sets up competition between owners to accept the offer immediately. This facilitates the optimum response time and user experience for the renter.

As yet another example, the addition of pay-as-you-drive insurance mitigates the need for the renter to maintain or purchase separate insurance. This streamlines the overall rental experience and increases convenience for the renter. It likewise removes and/or minimizes risk and liability from the owner.

As yet another example, the addition of automatic location technology circumvents the need to consistently re-park the vehicle in the same location. This enables the owner to rent out their vehicle dynamically from any location. It further enables the utility-based computation of gas and/or electricity usage and pay-as-you-drive insurance.

As yet another example, the addition of a digital keyless entry system circumvents the need to exchange physical keys. This allows the owner to rent out their vehicle without being in proximity of the vehicle and provides increased convenience for the renter.

In some embodiments, the on-demand third party asset rental platform further includes a smart phone push. In some embodiments, the smart phone push provides the capability to push real-time notifications directly to owner and renter smart phones and enables a fully on-demand rental system that provides the optimum response time and convenience for the owner and renter.

In some embodiments, the on-demand third party asset rental platform further includes social network profiles. In some embodiments, the social network profiles provide for an integration of the social graph, which enables renters and owners to browse one another's social profiles prior to sending or accepting a CRO and enables an increased level of trust and convenience for the owner and renter.

In some embodiments, the on-demand third party asset rental platform further includes privacy filters. In some embodiments, the privacy filters provide the capability for the user to specify privacy filters based on various parameters including social connection, location, time of day, feedback rating, and so on. This enables a car owner to define when, where, and to whom their car is available for rent.

In some embodiments, the on-demand third party asset rental platform further includes pay-as-you-drive insurance. In some embodiments, the pay-as-you-drive insurance enables a complete rental solution for the renter to cover their usage of the car and can be auto-calculated based on distance traveled and/or the rental duration.

In some embodiments, the on-demand third party asset rental platform further includes an ignition key exchange system. In some embodiments, the ignition key exchange system provides the addition of a process or technology-enabled lockbox whereby the owner can manually or automatically give the location of the vehicle's ignition key. In some embodiments, this is the vehicle's valet key, which, for example, gives benefit to the car owner as he/she can securely give the renter access to the vehicle's valet key, without giving access to the contents in valet-secured areas of the car (e.g., glove box, trunk).

In some embodiments, the on-demand third party asset rental platform further includes an integration of automatic-location technology. In some embodiments, the integration of Automatic Vehicle Location technology removes the need for the owner to specify a “home” location for the vehicle and enables a user's vehicle to be rentable at more times throughout the day (e.g., at work and at home) and at multiple home locations.

In some embodiments, the on-demand third party asset rental platform further includes automatic fuel (e.g., gas, electricity, and/or other fuel source(s)) consumption charge. In some embodiments, the automatic fuel consumption charge is combined with Automatic Vehicle Location technology, and the fuel consumption can be automatically calculated and charged to the renter. For example, this approach is useful for short trips that may not necessitate a stop at a gas station and provides utility to the renter as it avoids stopping for gas on short rentals.

In some embodiments, the on-demand third party asset rental platform further includes providing a keyless entry token. In some embodiments, after acceptance of a conditional rental request, a digital access key is created that facilitates keyless entry into the rented vehicle. In some embodiments, the digital access key is transmitted as a digital access token to a computerized entry system in the vehicle. For example, by using a digital key, the renter can access the vehicle without the need to collect a physical key from the owner.

In some embodiments, the on-demand third party asset rental platform further includes cryptographic security. In some embodiments, cryptographic security facilitates a cryptographically secure technique of transmitting digitally signed conditional rental requests to owners in which, for example, all owner-renter communication is intermediated and digitally authenticated by the central controller. For example, such secure communication techniques ensure that no user can maliciously spoof the identity of another user in the system.

In some embodiments, the on-demand third party asset rental platform further includes a renter-specified price. In some embodiments, the renter-specified price is provided as part of the conditional rental request that enables renters to make conditional rental requests at a price level that differs from the set price of the owner. For example, this gives the added benefit of ensuring the marketplace is efficient and that pricing varies with demand.

In some embodiments, the on-demand third party asset rental platform further includes automatic rental request expiry. In some embodiments, automatic rental request expiry facilitates the capability for the central controller to expire conditional rental requests automatically after a period of time. For example, this ensures the system does not include stale conditional rental requests that are binding upon the renter.

In some embodiments, the on-demand third party asset rental platform further includes an on-demand ride sharing system. In some embodiments, the on-demand ride sharing system that automatically publicizes the origin and destination locations when a renter has a conditional rental request accepted. For example, this publishing can be provided in a number of different ways. In some embodiments, this publishing happens using a PubSub mechanism whereby other nearby renters (“nearenters”) are automatically notified that someone in the area is heading to a particular destination. In some embodiments, the nearenters can send a conditional rideshare request, which may include a price amount, to join the ride. For example, this price can either be specified by the nearenter, automatically by the system, or the renter.

In some embodiments, the on-demand third party asset rental platform further includes a digital vehicle inspection (“digital walkaround”). In some embodiments, a digital vehicle inspection that occurs after a conditional rental request is accepted but prior to first accessing the vehicle. In some embodiments, the renter or the owner uses a smart phone to perform a digital walkaround of the vehicle and electronically notes any damages using one or multiple text, audio, photo, or video formats. In some embodiments, these digital walkaround notes are transmitted back and stored on a database on a central server creating a live inspection log for each vehicle. For example, the live inspection log can optionally be transmitted to the renter or owner to show historical damage prior to submitting the new inspection results.

In some embodiments, the on-demand third party asset rental platform further includes a feedback rating system. In some embodiments, the feedback and rating system allows owners and renters to rate one another at the end of a rental transaction. In some embodiments, both the owner and/or the owner's vehicle is rated by the renter, and the renter is rated by the owner. For example, this sets up a trust system that encourages positive member behavior, generally benefitting both renters and owners.

In some embodiments, the on-demand third party asset rental platform is applied to vehicles as well as various other industries including, for example, home, boat, plane, jet, and/or sports or other transportation equipment (e.g., bicycles, skis, and/or other sports or transportation equipment) rentals.

In some embodiments, the on-demand third party asset rental platform further includes recommended hourly rates for rentals based on vehicle properties, such as manufacturer, model, and year.

In some embodiments, the on-demand third party asset rental platform further includes the ability to dynamically optimize insurance based on time of day and territory.

In some embodiments, a renter specifies a preference based CRO. For example, in a preference based CRO, the renter can specify their order of preference for potentially available vehicles for a particular rental request, such as by selecting the following preferences: first choice=car #3 (C3), second choice=car #37 (C37), and third choice=car #17 (C17). As another example, CROs can also be distributed based on such preference based CROs. As yet another example, acceptances can be processed based on such preference based CROs.

In some embodiments, CROs are distributed to potentially matching owners using an asynchronous protocol. In some embodiments, the asynchronous protocol for CRO distribution includes time based variations in distributing CROs to multiple different owners. For example, the asynchronous protocol for CRO distribution can include time based variations in distributing CROs to multiple different owners to provide one or more preferred owners, such as for a preference based CRO, an advanced opportunity to respond, to avoid collisions of accepting car owners, and/or based on other time and/or parameter based criteria, as described herein with respect to various embodiments. As another example, the CROs can be distributed based on a time delay for sending each CRO (e.g., until one or more acceptances or received or based on acceptances received based on a preference match and/or time limit). As yet another example, the CROs can be distributed to allow a specified time window for response for each owner, and if an acceptance is not received within the time window, the next owner is sent the next CRO, and so forth. Various other algorithms can be used to implement the asynchronous protocol in view of the various embodiments described herein to achieve various time and/or preference based criteria.

In some embodiments, average response time and/or average response rate and/or other information for each owner is tracked and stored. In some embodiments, such information is used as a factor for implementing a preference based CRO and/or asynchronous protocol for CRO distribution. For example, a CRO can be sent to the owner of C3 and allow twice the average response time for that owner before sending the CRO to the owner of C37, in which the owner of C3 then no longer has exclusivity for accepting the CRO as the owner of C37 may respond prior to the owner of C3 (e.g., and/or the CRO sent to the owner of C3 can expire based on a time period for expiration of the CRO).

In some embodiments, the CRO includes optional preferences. For example, the CRO can include an optional preference for an automatic transmission over manual transmission. As another example, the CRO can include an optional preference for different times for different cars. As yet another example, the CRO can include an optional preference for types and/or models of vehicles.

In some embodiments, the CRO is updated and an updated CRO is generated and distributed. For example, the CRO can be updated at a later point in time by adding additional cars and/or other options or preferences after forming the initial CRO. In some embodiments, the updated CRO is distributed to newly specified owners.

In some embodiments, the CRO is automatically accepted based on preferences and/or other parameter settings that can be specified by an owner. For example, an owner can set auto-approve for certain time windows and/or certain parameters for renting their vehicle. As another example, an owner can specify a set of renters by name, by social relationship, by group (e.g., employee at the same organization, a student at the same university, and/or other group relationship), a certain class of renters (e.g., friends or friends of friends and/or favorites; or a certain level of driver rating in a social car sharing network), and/or other parameters or criteria or combinations thereof.

In some embodiments, a driver rating (“driver score”) can be generated and/or updated using driver information history from telematics hardware (“carkit”) installed in the vehicle driven by the driver (e.g., the carkit can record acceleration and speed related information possibly correlated with location information to determine speed driven relative to posted speed limits on roads traveled on during a driving route) to supplement DMV related driver record information and/or owner feedback.

In some embodiments, a CRO can include renter attributes that enable the owner to determine the trust and risk associated with accepting the CRO. For example, this can include the renter's feedback rating, previous rental activity, shared connections on a social network, driving record information, driver score, and/or other parameters or criteria or combinations thereof

In some embodiments, a “rent it now” option allows owners to broadcast that their vehicle is available to rent instantly for a specified time period and/or other options/preferences. For example, the owner can indicate offer the rent it now option only to a certain class of renters.

In some embodiments, the CRO is automatically generated based on parameters input by the renter. For example, instead of the renter manually selecting specific vehicles to possibly rent for a particular rental request, the CRO can be automatically generated based on parameters input by the renter, such as a type of car, automatic transmission, geography/location, dates and times, maximum price, and/or other parameters. Automatic CRO generation can be an initial option for the renter. As another example, the automatic CRO generation can be used as a default response if a custom CRO fails to result in an agreed rental (e.g., within a user specified and/or default period of time). For example, if the custom CRO fails to result in at least one acceptance, then an automatic CRO can be generated and displayed to the renter as a pre-selected bundle. As yet another example, automatic CRO generation can be offered as an initial option, possibly in parallel with the custom CRO option, and/or as a default if the custom CRO fails to generate an acceptance within a default or user specified period of time. This default automatic CRO generation approach can provide the potential renter more options and possibly avoid frustration if a custom CRO failed to generate at least one acceptance.

In some embodiments, the renter can maintain a list of favorite or preferred vehicles. For example, a custom CRO can be auto populated based on that preferred vehicles list associated with the renter.

In some embodiments, the owner sends a response that includes an alternative date/time interval for the requested vehicle rental. In some embodiments, the renter can accept the counter offer for the renter with the alternative date time interval resulting in a vehicle rental acceptance. In some embodiments, the owner sends a response that includes other counter offer information, such as a location for picking up the vehicle and/or returning the vehicle and/or other vehicle rental terms.

In some embodiments, differentiated pricing is provided based for each renter. For example, differentiated pricing can be provided based on a renter identity and/or renter class, such as a friend or good driver class. As another example, differentiated pricing can be provided based on date/time for the vehicle rental (e.g., higher pricing for Friday nights than Monday nights) and/or based on other parameters or criteria. As yet another example, differential pricing can include free (e.g., an owner may choose to not charge a certain class of users, such as for family or close friends).

In some embodiments, a renter is only required to pay for the vehicle rental after the time period of the vehicle rental. For example, the owner may only require that the renter pay what they can after completion of the vehicle rental (e.g., to possibly compensate the owner for gas usage and/or based on their ability to pay at a later date). In some embodiments, differential pricing for asset rentals includes “pay what you can.” In this “pay what you can” model, the conditional rental is accepted, but the price is left open. At the end of the rental, the renter decides the price to pay the owner. This can be restricted to a certain class of renter by the owner. Additionally, the owner can specify a minimum price they would like, but the renter can opt to pay more than this minimum (e.g., “pay what you can but at least $10 please!”).

In some embodiments, the owner pays for the rental fees on behalf of the renter. In one example, the owner pays for the driver's insurance for the renter's user of the vehicle. In another example, a minimum vehicle rental charge requested by the owner can be based on at least a calculated cost of insurance coverage for that renter to drive the vehicle for that rental period. In some embodiments, a service fee includes a rental insurance cost for an authorized service related rental (e.g., university or enterprise fleet or other vehicle rental service).

In some embodiments, the renter is verified based on vehicle rental information. For example, the renter can be verified based on driving record information, a driver's license number (e.g., executed on demand, either synchronously, in real-time when the request is initiated or received, or asynchronously, executing, for example, a multi-jurisdictional Driver Motor Vehicles (DMV) search, which can take about 30 seconds to several minutes to complete), on vehicle rental payment information (e.g., a credit card check can be performed based on the requesting renter's provided credit card number, and/or on social graph information.

In some embodiments, the price of insurance for a rental is determined based on a computed driver score and/or alternate trust and risk metrics such as a multi-jurisdictional driver record check.

In some embodiments, a social connection or social relationship between the renter and a first owner is determined (e.g., based on a social graph). For example, some or all of the social graph information can be imported from an existing social network (e.g., using a seed social graph data from a third party social graph source, in which the social graph includes relationships between renters and owners, and possibly between renters and other renters, and/or owners and other owners), such as Facebook®, MySpace®, and/or LinkedIn®. In some embodiments, the social graph can be generated or updated, in which the social graph includes relationships between the renter and the plurality of owners.

### DESCRIPTION OF THE FIGURES

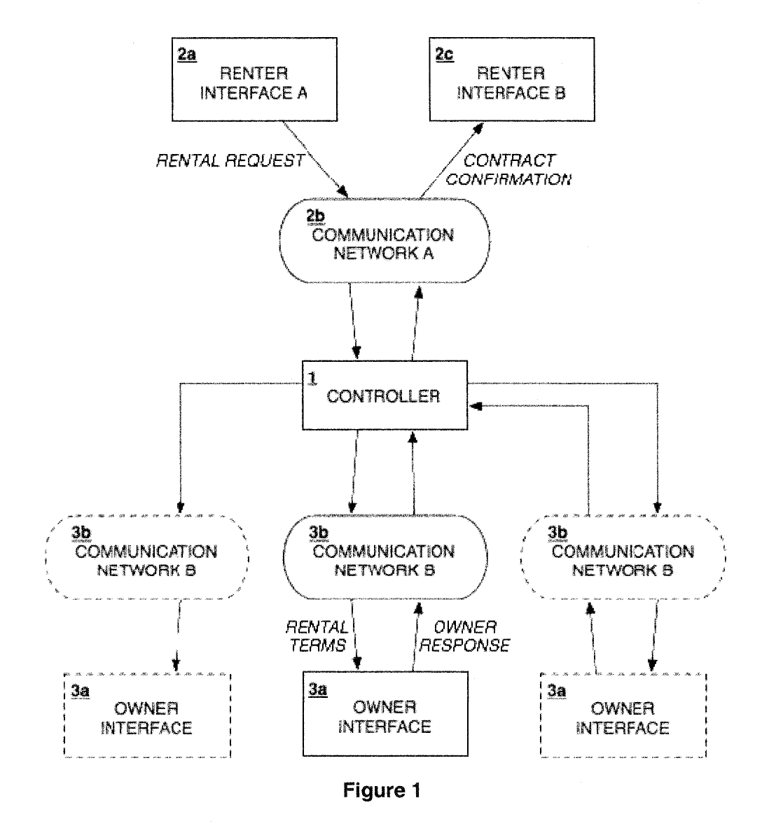

FIG. 1 is a functional diagram of an on-demand third party asset rental platform in accordance with some embodiments. As shown, the on-demand third party asset rental platform includes three basic functioning modules: a Controller 1, a set of Renter Interfaces 2a/2c, and a set of Owner Interfaces 3a. In some embodiments, the interfaces (2a/2c/3a) include web applications, mobile applications, and/or SMS/MMS applications. In some embodiments, the on-demand third party asset rental platform includes physical system components (not shown in FIG. 1), such as hard disks, processors, servers, and memory, as well as standard software and hardware components such as data stores (e.g., databases), operating systems, application servers, account settings, and other common elements as would be apparent to one of ordinary skill in the art.

As shown in FIG. 1, the Controller 1 is in communication with the Renter Interfaces 2a/2c via a communication network A 2b (e.g., the Internet, in which the Renter Interfaces 2a/2c are possibly using a wireless network connection, such as a 3G/4G cellular network connection or Wi-Fi network connection, to communicate on the Internet). For example, the Renter Interface 2a can communicate a rental request and the Renter Interface 2c can receive a contract confirmation (e.g., CRO acceptance from a selected asset owner) as shown.

As also shown in FIG. 1, the Controller 1 is in communication with the Owner Interfaces 3a via a communication network B 3b (e.g., the Internet, in which the Renter Interfaces 2a/2c are possibly using a wireless network connection, such as a 3G/4G cellular network connection or Wi-Fi network connection, to communicate on the Internet). For example, an Owner Interface 3a can communicate an owner response (e.g., an acceptance, counter offer, or a rejection) in response to received rental terms (e.g., a CRO) as also shown.

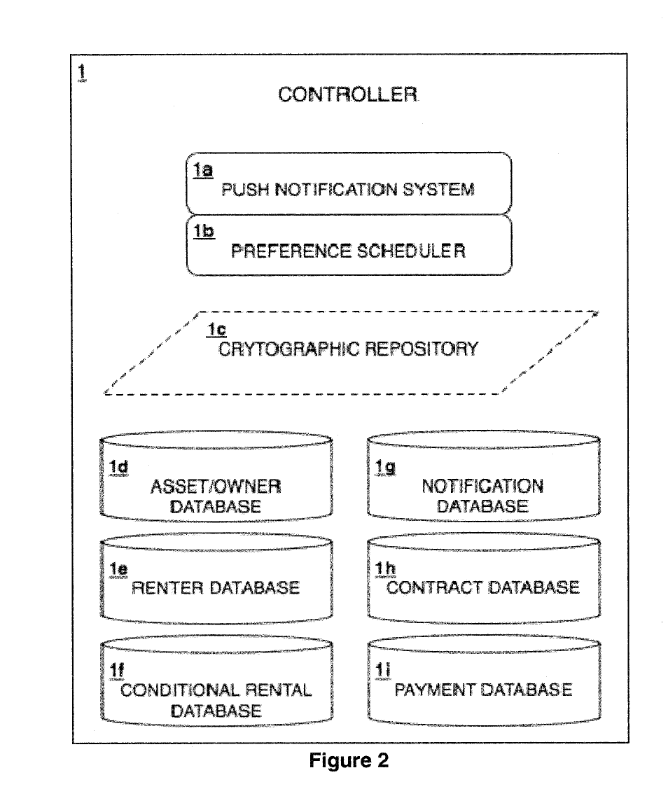

FIG. 2 is a functional diagram of a controller of the on-demand third party asset rental platform in accordance with some embodiments. In some embodiments, the Controller 1 mediates interactions between the renter and the asset owner during the process of forming and accepting a Conditional Rental Offer (CRO). In some embodiments, the Controller 1 includes a Push Notification System 1a that handles the delivery of messages between renters and owners. For example, these messages include CROs and other notifications, and can be delivered using one or more push mechanisms using various push message delivery techniques. In some embodiments, the Controller 1 includes a Preference Scheduler 1b that manages the delivery of CROs from renters to owners. In some embodiments, based on the desirability of each asset, the preference scheduler dynamically determines the optimal delivery schedule for the CROs to third party asset owners as well as any exclusivity periods afforded to them.

In some embodiments, the Controller 1 includes a Cryptographic Repository 1c that is used to digitally encrypt, sign, and securely communicate between the system (e.g., Controller 1) and Owners, as well as between the system (e.g., Controller 1) and Renters. In some embodiments, the Cryptographic Repository 1c is also used to sign and secure sensitive information stored in system databases and/or other data stores that contain financial, personal, tokens for asset access as described herein such as for vehicle access, and/or other sensitive information.

In some embodiments, the Controller 1 includes an Asset/Owner Database 1d that stores information about third-party owners and assets including account information, asset validation and related credentials. For example, the Asset/Owner Database 1d can store an average response time and/or average response rate for one or more of the asset owners.

In some embodiments, the Controller 1 includes a Renter Database 1e that stores information about renters including account information and renter eligibility. For example, Renter Database 1e can also store renter preference information (e.g., which can be used to automatically suggest or pre-populate preferences for custom CROs or generate CROs).

In some embodiments, the Asset/Owner Database 1d and the Renter Database 1e also store social graph related information for each of the renters, each of the owners, and their social connections between renters and other renters, between owners and other owners, and/or between renters and owners. In some embodiments, this social graph related information is stored in a social graph data store of the Controller 1. In some embodiments, this social graph related information is stored in a social graph related data store in another component of the system and/or elsewhere in the on-demand third party asset platform.

In some embodiments, the Controller 1 includes a Conditional Rental Database 1f that stores information on conditional rental offers (CROs) entered into by renters. For example, Renter Database 1e can also store owner preference information (e.g., which can be used to automatically filter and/or respond to CROs based on such preferences). I

In some embodiments, the Controller 1 includes a Notification Database 1g that stores Renter<->System<->Owner communication including CRO and acceptance notifications. In some embodiments, the Controller 1 includes a Contract Database 1h that stores legal contracts and agreements entered into between Renters and Owners. In some embodiments, the Controller 1 includes a Payment Database 1i that stores payment identifiers, transactions, and detail for rental transactions.

In some embodiments, the databases 1d-1i of the Controller 1 are stored another component of the system and/or elsewhere in the on-demand third party asset platform. In some embodiments, one or more of these databases 1d-1i are integrated into a single database. In some embodiments, one or more of these databases 1d-1i are stored in a relational or object based or object relational database. In some embodiments, the information described above as stored in the databases 1d-1i of the Controller 1 are stored as data stores using various other techniques (e.g., indexed HTML or XML files).

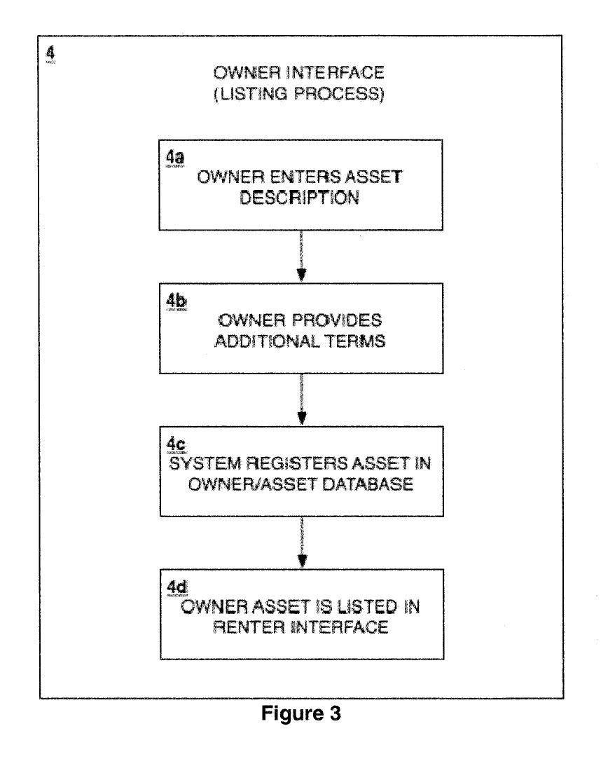

FIG. 3 is a flow diagram 4 of an owner asset listing process using an owner interface in accordance with some embodiments. In some embodiments, the Owner Interface is a mobile application (e.g., a mobile app on a smart phone, such as app for an Apple iPhone® or Google Android® based mobile phone) that allows the asset owner to describe an asset and register it in the Asset/Owner Database 1d over a cellular network connection (e.g., 3G or 4G cellular network connection) or a wireless Internet connection (e.g., a Wi-Fi connection). In some embodiments, the Owner Interface is a browsable web application and/or web based service accessed over the Internet using a device executing a web browser (e.g., a computer executing a web browser or a smart phone executing a web browser).

In some embodiments, it is assumed that rentable assets are also used in an ad hoc and unscheduled manner by the asset owner. Rather than attempt to specify exact availability, the asset owner simply indicates that his asset is available often though the owner may not know exactly when in advance. In some embodiments, a larger granularity level of scheduling and the owner to input approximate blocks of time when the asset is typically available or unavailable.

Referring now to FIG. 3, in some embodiments, third party owners list their rentable assets through one or more Owner Interfaces using the process described below with respect to FIG. 3. At stage 4a, the owner enters a description of the asset. At stage 4b, the owner provides additional terms for the rental of the owner's asset, such as the scheduling of the availability of the owner's asset, location of the asset, price for the rental of the asset, driver rating requirements for rental of the asset, and/or other information. At stage 4c, the system registers the asset in the asset owner's database. At stage 4d, the owner's asset is listed in the renter interface. In some embodiments, the owner's asset is listed in the renter interface and presented within a smart phone or computer application for the on-demand third party asset platform. In some embodiments, the owner's asset is listed in the renter interface and presented within a web page for a web-based service for the on-demand third party asset platform.

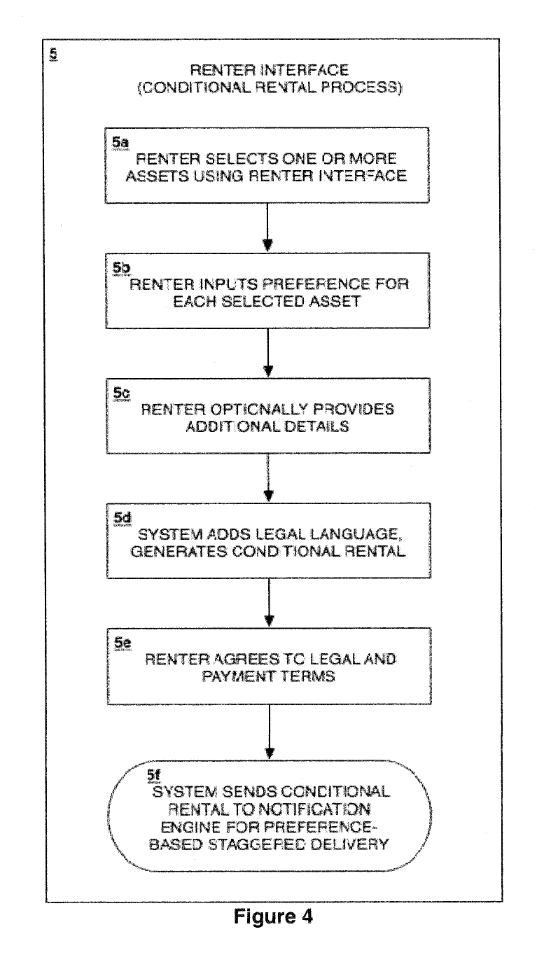

FIG. 4 is a flow diagram 5 of a Conditional Rental Offer (CRO) process using a renter interface in accordance with some embodiments. In some embodiments, third-party renters browse rentable assets through one or more Renter Interfaces. Renters are aware that asset availability is not guaranteed and therefore select more than one similar or substitutionary asset, or in some embodiments, an automatically generated CRO is used as described herein. In some embodiments, the renter (optionally) specifies the desirability of each asset relative to one another, or designates them as equally desirable. This selection forms a Conditional Rental Offer (CRO). In some embodiments, an automatically generated CRO is provided. In some embodiments, an automatically generated CRO is provided as a default to a custom CRO that the user can select or have used if the custom CRO fails to yield an acceptance (e.g., a confirmed rental transaction or rental agreement).

In some embodiments, the Renter agrees to the binding nature of the legal and payment terms of the CRO and submits it. The Controller 1a accepts the CRO, stores it in the Conditional Rental Database 1e, and notifies (“pushes”) the CRO to one or more of the selected third party asset owners.

Referring now to FIG. 4, in some embodiments, renters complete the steps described with respect to FIG. 4 to form a CRO. At stage 5a, the renter selects one or more assets using the renter interface. At stage 5b, the renter (optionally) inputs preferences (if any) for each asset as a set of preferences if offered by the on-demand third party asset rental platform. In some embodiments, the absence of preference input results in the assets being given or treated as having equal desirability by the user. At stage 5c, the renter optionally provides additional rental details and conditions. At stage 5d, the renter interface (e.g., or another component of the on-demand third party asset rental platform) generates legal language to create a binding conditional rental. At stage 5e, the renter is requested to agree to the legal and payment terms. At stage 5f, the renter interface (e.g., or another component of the on-demand third party asset rental platform) generates the CRO and sends the CRO to the notification engine for preference based staggered delivery as described herein with respect to various embodiments.

In some embodiments, the renter can is not requested or required to input preferences for each selected asset to generate a custom CRO that includes user input preferences or desirability for the selected asset(s) (i.e., stage 5b is not required or can be bypassed by the renter). In some embodiments, the renter interface (e.g., or another component of the on-demand third party asset rental platform) generates its own desirability scheme to provide an automatically generated CRO. For example, the system can define desirability as a combination of a score indicating closeness of the asset to the owner combined with its price. As another example, the system can define equal desirability for all assets in the CRO. As yet another example, asset owners can pay a premium to increase the desirability of their asset. As yet a further example, the system can define desirability based on a user input preference to be used for user requested rentals, based on a user preference input history (e.g., machine learned user preferences for assets), and/or based on various other criteria or parameters.

In some embodiments, a price is not a required input into the renter interface to generate a CRO. Unlike a conditional purchasing system, which has a primary motivation of price optimization, the on-demand third party asset rental platform is not merely focused on the optimization of price for the renter as discussed above. Additionally, unlike a conditional purchase offer system, the on-demand third party asset rental platform cannot guarantee a response from a particular owner as the owner is one of a large number of third party owners supplying their asset on an ad hoc availability basis as discussed above.

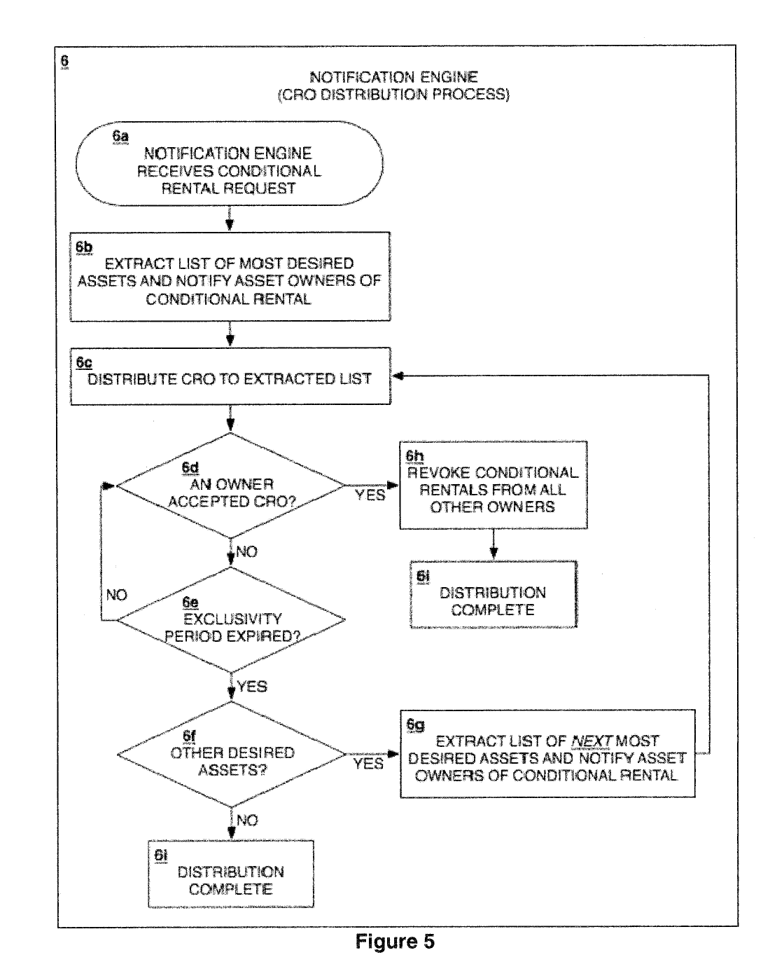

FIG. 5 is a flow diagram 6 of a Conditional Rental Offer (CRO) distribution using a notification engine in accordance with some embodiments. In some embodiments, the Notification Engine of the Controller 1 follows the CRO distribution process described below with respect to FIG. 5. At stage 6a, the Notification Engine receives a conditional rental request. At stage 6b, the Notification Engine then extracts a list of the most desired assets from the ordered set for determining the asset owners that are to be notified of the conditional rental (e.g., using an asynchronous CRO distribution protocol).

At stage 6c, the Notification Engine distributes the CRO to those asset owners 6c (e.g., using an asynchronous CRO distribution protocol). In some embodiments, the Preference Scheduler 1b computes a ranked order of the most desirable assets based on a plurality of factors including, for example, preferences specified by the renter, location, price, average owner response time, owner feedback rating, and/or other criteria. For example, desirability can be determined based on preferences specified by the renter, such as distance of the asset from the renter and/or price to determine the optimal ranking. As another example, desirability can be determined solely based on a distance from the renter and does not require preferences specified by the renter.

The CRO is delivered along with an exclusivity that it will not be delivered to the remaining asset owners until either (a) one of the asset owners receiving the CRO sends back an acceptance at stage 6d, or (b) the exclusivity period expires at stage 6e.

In some embodiments, once a single third-party owner accepts the CRO, all other offers are revoked as shown at stage 6h. If no owners accept the CRO within the exclusivity period as shown at stage 6e, and the renter's CRO includes other desired assets as shown at 6f, then the CRO is distributed to the owners of the next most desirable set of owners at stage 6g. This process repeats until an owner accepts the CRO, until the CRO is declined by all owners, or until the CRO expires with any acceptance. At stage 6i, the CRO distribution process is completed.

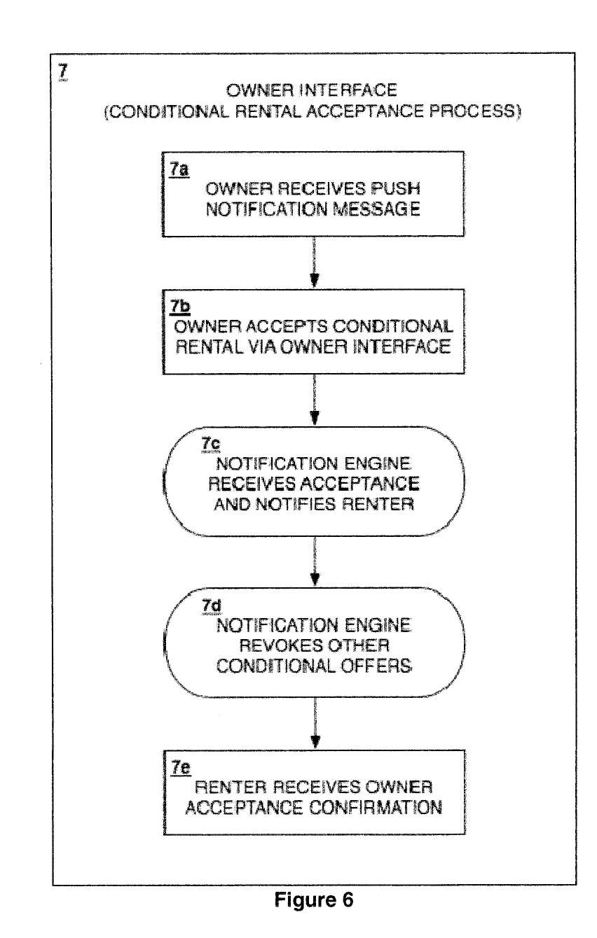

FIG. 6 is a flow diagram 7 of a Conditional Rental Offer (CRO) acceptance in accordance with some embodiments. In some embodiments, owners complete the steps outlined in FIG. 6 to accept a CRO. At stage 7a, an owner receives a CRO notification, for example, which is sent as a push notification message. At stage 7b, the owner accepts the CRO via an owner interface (e.g., owner interface 3a). At stage 7c, the notification engine receives the acceptance from the owner and notifies the renter of the received acceptance from the owner. At stage 7d, the notification engine revokes other CROs (e.g., if any, that were previously distributed/transmitted to one or more other asset owners). At stage 7e, the renter receives the owner's acceptance confirmation.

In some embodiments, prior to acceptance, the renter is verified based on one or more parameters, criteria, or verification checks. In some embodiments, prior to acceptance, the renter is verified based on vehicle rental information. In some embodiments, prior to acceptance, the renter is verified based on driving record information and/or payment information. In some embodiments, prior to acceptance, the renter is verified based on social graph information.

In some embodiments, once a conditional request is accepted and binding, the on-demand third-party asset rental platform coordinates a meeting between the owner and renter to exchange the asset. For example, in the case in which the asset is a vehicle, coordination of a meeting between the owner and renter to exchange the asset can involve an exchange of car keys to operate the vehicle. The on-demand third-party asset rental platform informs both parties about the logistics of the meeting (e.g., via an e-mail, text message, voice message, and/or other form of notification or communication), suggesting the location, and providing contact information for the other party. In some embodiments, the platform also provides the social profiles each party to the other.

In some embodiments, once a conditional request is accepted and binding, the on-demand third party asset rental platform creates a cryptographically secure digital access token for the asset. For example, the token can be transmitted to the renter and permit the renter to operate the asset. As another example, in the case in which the asset is a vehicle, a secure code can be required for unlocking the vehicle doors. The renter could then use a key stored in the vehicle to operate the vehicle. As yet another example, the vehicle can be operated as part of the digital access token without requiring a separate physical key.

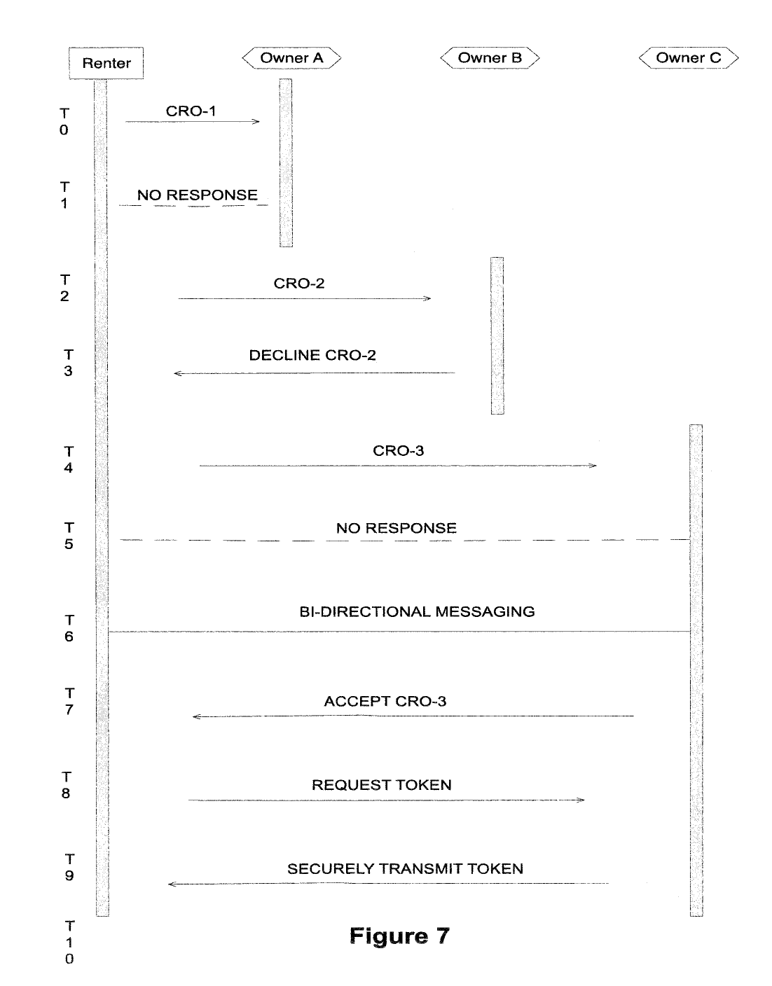

FIG. 7 is a messaging sequence diagram for an asynchronous CRO distribution protocol for an on-demand third party asset rental platform in accordance with some embodiments. In some embodiments, the on-demand third party asset rental platform implements an asynchronous protocol for CRO distribution. In some embodiments, a renter specifies a preference based CRO. For example, in a preference based CRO, the renter can specify their order of preference for potentially available vehicles for a particular rental request, such as by selecting the following preferences: first choice=car #3 (C3) owned by Owner A, second choice=car #37 (C37) owned by Owner B, and third choice=car #17 (C17) owned Owner C.

In some embodiments, the CROs are distributed based on such preference based CROs using an asynchronous CRO distribution protocol. In some embodiments, the asynchronous protocol for CRO distribution includes time based variations in distributing CROs to multiple different owners. For example, the asynchronous protocol for CRO distribution can include time based variations in distributing CROs to multiple different owners to provide one or more preferred owners, such as for a preference based CRO, an advanced opportunity to respond, to avoid collisions of accepting car owners, and/or based on other time and/or parameter based criteria, as described herein with respect to various embodiments. As another example, the CROs can be distributed based on a time delay for sending each CRO (e.g., until one or more acceptances or received or based on acceptances received based on a preference match and/or time limit). As yet another example, the CROs can be distributed to allow a specified time window for response for each owner, and if an acceptance is not received within the time window, the next owner is sent the next CRO, and so forth. Various other algorithms can be used to implement the asynchronous protocol in view of the various embodiments described herein to achieve various time and/or preference based criteria.

In some embodiments, average response time and/or average response rate and/or other information for each owner is tracked and stored. In some embodiments, such information is used as a factor for implementing a preference based CRO and/or asynchronous protocol for CRO distribution. For example, a CRO can be sent to an owner of a preferred car (e.g., most preferred by the Renter for this particular CRO), and allow twice the average response time for that owner to respond before sending another CRO to the owner of another car that is less preferred by the renter, in which the owner of the most preferred car then no longer has exclusivity for accepting the CRO as the owner of the slightly less preferred car may respond prior to the owner of the most preferred car (e.g., and/or the CRO sent to the owner of the most preferred car can expire based on a time period for expiration of that CRO).

Referring now to FIG. 7, at time T0, a first conditional rental offer (CRO-1) is sent to a first selected owner (Owner A) from a Renter. In some embodiments, Controller 1 and/or other components of the on-demand third party asset platform implement the asynchronous CRO distribution. In some embodiments, the on-demand third party asset rental platform further includes cryptographic security. In some embodiments, cryptographic security facilitates a cryptographically secure technique of securely transmitting digitally signed CROs to owners in which, for example, all owner-renter communication is intermediated and digitally authenticated by the central controller. For example, such secure communication techniques ensure that no user can maliciously spoof the identity of another user in the system. At time T1, a response from Owner A is not received. In some embodiments, a period of exclusivity for responding to CRO-1 for Owner A expires after time period T1. In some embodiments, the exclusivity time period is calculated based on an average response time and/or average response rate and/or other information for Owner A.

At time T2, a second conditional rental offer (CRO-2) is sent to a second selected owner (Owner B) from the Renter. At time T3, a DECLINE response is sent to the Renter from Owner B.

At time T4, a third conditional rental offer (CRO-3) is sent to a third selected owner (Owner C) from the Renter. At time T5, a response from Owner C is not received. At time T6, bi-directional messaging is communicated between the Renter and Owner C. For example, Owner C may contact the Renter with follow-up questions or requests for additional information (e.g., where the Renter intends to drive the vehicle, the relationship between the renter with the owner and/or with friends or family of the renter and/or the renter's association with a company or school). At time T7, an ACCEPT response for accepting CRO-3 is sent to the Renter from Owner C.

At time T8, a REQUEST TOKEN message is sent to Owner C from the Renter to request a token for access to the vehicle. In some embodiments, the on-demand third party asset rental platform further includes providing a keyless entry token (e.g., using an AVL integrated into the vehicle that supports the use of such digital access keys or tokens to facilitate keyless entry into the vehicle). In some embodiments, after acceptance of a conditional rental request, a digital access key is created that facilitates keyless entry into the rented vehicle. In some embodiments, the digital access key is transmitted as a digital access token to a computerized entry system in the vehicle. For example, by using a digital key, the renter can access the vehicle without the need to collect a physical key from the owner.

At time T9, the token is securely transmitted to the Renter from Owner C. In some embodiments, the on-demand third party asset rental platform further includes cryptographic security. In some embodiments, cryptographic security facilitates a cryptographically secure technique of securely transmitting the token from the owner to the renter (e.g., digitally signing the token, encrypting the token using PKI or other encryption techniques, and/or communicating using SSL or other secure/encrypted communication techniques). At time T10, the messaging sequence is completed.

In some embodiments, an on-demand third party asset rental platform is provided for assets other than vehicles. In some embodiments, the architecture and components for implementing the techniques described herein can be used in fewer or greater number of functional components, located in different hardware elements or network locations, and/or other variations as would now be apparent to one of ordinary skill in the art in view of the various embodiments described herein.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
receive a request for a vehicle rental from a renter; and
in response to the request for a vehicle rental, communicate a conditional rental offer as a plurality of conditional rental offers distributed to a plurality of owners, wherein each of the owners specifies the owner's rental terms; and
a memory coupled to the processor and configured to provide the processor with instructions.

2. The system recited in claim 1, wherein the owner's rental terms of one or more of the owners' includes a rental price and a plurality of additional rental terms.

3. The system recited in claim 1, wherein a plurality of vehicles are corporate fleet vehicles associated with a corporate entity, and fees associated with rentals of the corporate fleet vehicles by authorized corporate fleet vehicle users are charged back to the corporate entity.

4. The system recited in claim 1, wherein the conditional rental offers include one or more required preferences and one or more required preferences related to the vehicle rental.

5. The system recited in claim 1, wherein the owner pays a portion of the rental cost for an approved vehicle rental.

6. The system recited in claim 1, wherein the owner pays rental insurance cost for an approved vehicle rental, and the vehicle rental price includes a calculated cost of the rental insurance cost for the approved vehicle rental.

7. The system recited in claim 1, wherein the memory is further configured to provide the processor with instructions which when executed cause the processor to:
store response information for a plurality of owners, wherein the response information includes an average response time and/or average response rate.

8. The system recited in claim 1, wherein the memory is further configured to provide the processor with instructions which when executed cause the processor to:
communicate the plurality of conditional rental offers to the plurality of owners asynchronously to distribute the conditional rental offers to provide one or more selected of the plurality of owners advanced opportunities to respond to the conditional rental offers.

9. The system recited in claim 1, wherein the memory is further configured to provide the processor with instructions which when executed cause the processor to:
communicate updated conditional rental offers.

10. The system recited in claim 1, wherein the memory is further configured to provide the processor with instructions which when executed cause the processor to:
automatically approve the conditional rental offer for a first owner based on one or more parameters.

11. The system recited in claim 1, wherein the memory is further configured to provide the processor with instructions which when executed cause the processor to:
communicate an acceptance of the conditional rental offer for a first owner; and
communicate a digital access key that facilitates keyless entry into the first owner's vehicle, wherein the digital access key is a digital access token to a computerized entry system installed in the first owner's vehicle.

12. The system recited in claim 1, wherein the memory is further configured to provide the processor with instructions which when executed cause the processor to:
automatically approve the conditional rental offer for a first owner based on one or more parameters; and
communicate the approved response from the first owner.

13. The system recited in claim 1, wherein the memory is further configured to provide the processor with instructions which when executed cause the processor to:
communicate a plurality of messages between the renter and a first owner

14. The system recited in claim 1, wherein the memory is further configured to provide the processor with instructions which when executed cause the processor to:
automatically generate the conditional rental offer based on a plurality of rental parameters input by the renter.

15. The system recited in claim 1, wherein the memory is further configured to provide the processor with instructions which when executed cause the processor to:
store a list of favorite vehicles associated with the renter.

16. The system recited in claim 1, wherein the memory is further configured to provide the processor with instructions which when executed cause the processor to:
store a list of preferred renters for a first owner, wherein one or more of the preferred renters are preauthorized for renting the first owner's vehicle.

17. The system recited in claim 1, wherein the memory is further configured to provide the processor with instructions which when executed cause the processor to:
calculate differentiating pricing for the renter for one or more of the owners based on a preference setting configured by the owner for one or more of the renters.

18. The system recited in claim 1, wherein the memory is further configured to provide the processor with instructions which when executed cause the processor to:
generate a rent it now offer for a first owner, wherein rent it now offer includes a plurality of required parameters including a time interval and a rental price.

19. The system recited in claim 1, wherein the memory is further configured to provide the processor with instructions which when executed cause the processor to:
verify the renter based on vehicle rental information.

20. The system recited in claim 1, wherein the memory is further configured to provide the processor with instructions which when executed cause the processor to:
verify the renter based on driving record information and/or payment information.

21. The system recited in claim 1, wherein the memory is further configured to provide the processor with instructions which when executed cause the processor to:
verify the renter based on social graph information.

22. The system recited in claim 1, wherein the memory is further configured to provide the processor with instructions which when executed cause the processor to:
determine a relationship between the renter and a first owner based on a social graph.

23. The system recited in claim 1, wherein the memory is further configured to provide the processor with instructions which when executed cause the processor to:
generate a social graph, wherein the social graph includes relationships between the renter and the plurality of owners.

24. A method, comprising:
receiving a request for a vehicle rental from a renter; and
in response to the request for a vehicle rental, communicating a conditional rental offer as a plurality of conditional rental offers distributed to a plurality of owners, wherein each of the owners specifies an owner's prices.

25. A computer program product, the computer program product being embodied in a computer readable storage medium and comprising computer instructions for:
receiving a request for a vehicle rental from a renter; and
in response to the request for a vehicle rental, communicating a conditional rental offer as a plurality of conditional rental offers distributed to a plurality of owners, wherein each of the owners specifies an owner's prices.
